(19) United States
(12) Patent Application Publication
(10) Pub. No.: US 2019/0047038 A1
(43) Pub. Date: Feb. 14, 2019

(54) WIRE HANDLING APPARATUS

(71) Applicant: The Charles Stark Draper Laboratory, Inc., Cambridge, MA (US)

(72) Inventors: Caprice Gray Haley, Cambridge, MA (US); Mitchell W. Meinhold, Cambridge, MA (US); Stephen Bellio, Cambridge, MA (US)

(21) Appl. No.: 16/059,361

(22) Filed: Aug. 9, 2018

Related U.S. Application Data
(60) Provisional application No. 62/544,279, filed on Aug. 11, 2017.

(51) Int. Cl. B21F 15/04; H02G 1/00

(52) U.S. Cl. CPC B21F 15/04; H02G 1/005

(57) ABSTRACT

A wire handling tool includes a frame, a first actuator having a proximal end attached to the frame and a first distal end including a first grasping member for grasping a wire. The first distal end is configured to move along a first axis, wherein movement of the first distal end causes movement of the grasped wire along the first axis. The wire handling tool includes a controller for controlling the first actuator according to a wire feeding sequence to move the wire along the first axis.

### RELATED APPLICATIONS

This application claims the benefit of U.S. Provisional Application 62/544,279, filed on Aug. 11, 2017, the contents of which is incorporated herein by reference.

### BACKGROUND

This invention relates to a wire handling apparatus.

Wires are typically manufactured in bulk and stored on wire carriers such as spools. Wire is often fed from a spool by pulling on a free end of the wire (e.g., using a pinch-roller system), rotating the spool itself (e.g., using a motor coupled to the pool), or both. Conventional wire handling apparatuses are designed to handle relatively low gauge (large diameter) wire.

### SUMMARY

In a general aspect, wire handling tool includes a frame, a first actuator having a proximal end attached to the frame and a first distal end including a first grasping member for grasping a wire, the first distal end configured to move along a first axis, wherein movement of the first distal end causes movement of the grasped wire along the first axis, and a controller for controlling the first actuator according to a wire feeding sequence to move the wire along the first axis.

Aspects may include one or more of the following features.

The first actuator may be movable between a first configuration of the wire feeding sequence with the first grasping member of the first distal end of the first actuator disengaged from the wire, the first distal end of the first actuator being disposed at a first position on the first axis, a second configuration of the wire feeding sequence with the first grasping member of the first distal end of the first actuator grasping the wire, the first distal end of the first actuator being disposed at the first position on the first axis, a third configuration of the wire feeding sequence with the first grasping member of the first distal end of the first actuator grasping the wire, the first distal end of the first actuator being disposed at a second position on the first axis, and a fourth configuration of the wire feeding sequence with the first grasping member of the first distal end of the first actuator disengaged from the wire, the first distal end of the first actuator being disposed at the second position on the first axis. A transition between the second configuration and the third configuration causes movement of the wire along the first axis.

The first actuator may include a number of sub-actuators, each sub-actuator of the number of sub-actuators having a proximal end attached to the frame and a distal end including a grasping element, wherein the corresponding grasping elements of the number of elongate sub-actuators form the first grasping member. The distal end of each sub-actuator of the number of sub-actuators may be configured to move in a number of directions including a direction along the first axis and a direction transverse to the first axis. Each sub-actuator of the number of sub-actuators may include an elongate piezoelectric actuator configured move the distal end of the sub-actuator by bending in response to an electrical stimulus.

The wire handling tool may include a second actuator having a second proximal end attached to the frame and a second distal end including a second grasping member for grasping the wire, the second distal end configured to move along the first axis, wherein movement of the second distal end causes movement of the grasped wire along the first axis, and the controller is further configured to control the second actuator according to the wire feeding sequence to move the wire along the first axis.

The first actuator and the second actuator may be movable between a first configuration of the wire feeding sequence with the first grasping member of the first distal end of the first actuator disengaged from the wire and the second grasping member of the second distal end of the second actuator grasping a first portion of the wire, the second distal end being disposed at a first position on the first axis, a second configuration of the wire feeding sequence with the first grasping member of the first distal end of the first actuator disengaged from the wire and second grasping member of the second distal end of the second actuator grasping the first portion of the wire, the second distal end being disposed at a second position on the first axis, a third configuration of the wire feeding sequence with the second grasping member of the second distal end of the second actuator disengaged from the wire and first grasping member of the first distal end of the first actuator grasping a second portion of the wire, the first distal end being disposed at a third position on the first axis, and a fourth configuration of the wire feeding sequence with the second grasping member of the second distal end of the second actuator disengaged from the wire and the first grasping member of the first distal end of the first actuator grasping the second portion of the wire, the first distal end being disposed at a fourth position on the first axis. A transition from the first configuration to the second configuration causes movement of the wire along the first axis and a transition from the third configuration to the fourth configuration may cause movement of the wire along the first axis.

The first actuator may include a first number of sub-actuators, each sub-actuator of the first number of sub-actuators having a proximal end attached to the frame and a distal end including a grasping element, wherein the corresponding grasping elements of the first number of elongate sub-actuators form the first grasping member and the second actuator includes a second number of sub-actuators, each sub-actuator of the second number of sub-actuators having a proximal end attached to the frame and a distal end including a grasping element, wherein the corresponding grasping elements of the second number of elongate sub-actuators form the second grasping member. The distal end of each sub-actuator of the first number of sub-actuators may be configured to move in a first number of directions including a direction along the first axis and a direction transverse to the first axis and the distal end of each sub-actuator of the second number of sub-actuators may be configured to move in a second number of directions including a direction along the first axis and a direction transverse to the first axis.

Each sub-actuator of the first number of sub-actuators may include an elongate piezoelectric actuator configured move the distal end of the sub-actuator by bending in response to an electrical stimulus and each sub-actuator of the second number of sub-actuators may include an elongate piezoelectric actuator configured move the distal end of the sub-actuator by bending in response to an electrical stimulus. The wire handling tool may include a substantially cylindrical elongate nozzle coupled to the frame and extending along the first axis, the nozzle having a channel extending therethrough for receiving the wire. A sidewall of the nozzle may include an opening through which the first grasping member extends for accessing the wire.

The wire handling tool may include a wire stripping apparatus including a second frame with a first wire stripping blade attached thereto and a wire stripping actuator having a proximal end attached to the second frame and a distal end with a second wire stripping blade attached thereto, wherein the first wire stripping blade opposes the second wire stripping blade. The controller may be further configured to control the wire stripping actuator according to a wire stripping sequence. The wire handling tool may include a rotation actuator for grasping and rotating the wire. The wire handling tool may include a bonding member for attaching the wire to a surface.

In another general aspect, a wire handling tool includes a frame, a contact surface, an actuator having a proximal end attached to the frame and a distal end, the distal end configured to move in a direction along a first axis and configured to move in a direction transverse to the first axis for pressing the wire against the contact surface. Movement of the distal end along the first axis when the wire is pressed against the contact surface causes movement of the wire along the first axis. The wire handling tool includes a controller for controlling the actuator according to a wire feeding sequence to move the wire along the first axis.

Aspects may include one or more of the following features.

The actuator may be movable between a first configuration of the wire feeding sequence with the distal end of the actuator disengaged from the wire, the distal end of the actuator being disposed at a first position along the first axis, a second configuration of the wire feeding sequence with the distal end of the actuator pressing the wire against the contact surface, the distal end of the actuator being disposed at the first position along the first axis, a third configuration of the wire feeding sequence with the distal end of the actuator pressing the wire against the contact surface, the distal end of the actuator being disposed at a second position along the first axis, and a fourth configuration of the wire feeding sequence with the distal end of the actuator disengaged from the wire, the distal end of the actuator being disposed at the second position along the first axis. Transitioning between the second configuration of the wire feeding sequence and the third configuration of the wire feeding sequence may cause movement of the wire along the first axis.

The distal end of the actuator may be configured to move in a first number of directions including a direction along the first axis and a direction transverse to the first axis. The actuator may include an elongate piezoelectric actuator, the elongate piezoelectric actuator configured move the distal end of the first by bending in response to an electrical stimulus and each sub-actuator of the second number of sub-actuators may include an elongate piezoelectric actuator configured move the distal end of the sub-actuator by bending in response to an electrical stimulus.

In another general aspect, a method for feeding, stripping, and bonding a wire, includes feeding a first portion of wire from a spool using a first wire handling tool, the first wire handling tool being configured according to some or all of the features described above, cutting the first portion of wire using a wire cutting tool attached to the first wire handling tool, grasping the first portion of wire using a second wire handling tool, the second wire handling tool being configured according to some or all of the features described above, moving the first portion of wire to a wire stripping apparatus using the second wire handling tool and stripping a first end of the first wire portion of wire using the wire stripping apparatus, grasping the first wire portion using a wire rotation apparatus and releasing the first portion of wire from the second wire handling tool, rotating the first portion of wire using the wire rotation apparatus, grasping the rotated first portion of wire using the second wire handling apparatus, moving the first portion of wire to the wire stripping apparatus using the second wire handling tool and stripping a second end of the first wire portion using the wire stripping apparatus, moving the second end of the first portion of wire to a first connection point using the second wire handling apparatus and attaching the second end of the first portion of wire to the first connection point using a bonding apparatus, and moving the first end of the first portion of wire to a second connection point using the second wire handling apparatus and attaching the first end of the first portion of wire to the second connection point using the bonding apparatus.

The first wiring tool may include a frame, a first actuator having a proximal end attached to the frame and a first distal end including a first grasping member for grasping a wire, the first distal end configured to move along a first axis, wherein movement of the first distal end causes movement of the grasped wire along the first axis, and a controller for controlling the first actuator according to a wire feeding sequence to move the wire along the first axis, and the second wiring tool may include a second actuator having a proximal end attached to the frame and a second distal end including a second grasping member for grasping a wire, the second distal end configured to move along a second axis, wherein movement of the second distal end causes movement of the grasped wire along the second axis, and a controller for controlling the second actuator according to a wire feeding sequence to move the wire along the second axis.

Aspects may have one or more of the following advantages.

Among other advantages, a wire handling apparatus and its method of use employs one or more piezoelectric actuators to precisely feed high gauge wire. The one or more piezoelectric actuators are controlled according to a wire feeding sequence. The wire feeding sequence causes the piezoelectric actuators to interact with and manipulate the wire such that a desired length of wire is precisely fed. Furthermore, the wire handling apparatus can be used to automate wiring of microelectronic circuitry.

Other features and advantages of the invention are apparent from the following description, and from the claims.

### DESCRIPTION OF DRAWINGS

FIG. 1 is a first embodiment of a wire handling apparatus.

FIG. 2 is a detailed view of a distal end of the wire handling apparatus of FIG. 1.

FIG. 3 is a piezoelectric actuator.

FIG. 4 is a wire feeding sequence for the wire handling apparatus of FIG. 1.

FIG. 5 is a second embodiment of a wire handling apparatus.

FIG. 6 is a wire feeding sequence for the wire handling apparatus of FIG. 5.

FIG. 7 is a third embodiment of a wire handling apparatus.

FIG. 8 is a wire feeding sequence for the wire handling apparatus of FIG. 7.

FIG. 9 is a wire cutting step of a wire feeding, stripping, and bonding sequence.

FIG. 10 is a first wire stripping step of the wire feeding, stripping, and bonding sequence.

FIG. 11 is a first wire transfer step of the wire feeding, stripping, and bonding sequence.

FIG. 12 is a wire rotation step of the wire feeding, stripping, and bonding sequence.

FIG. 13 is a second wire transfer step of the wire feeding, stripping, and bonding sequence.

FIG. 14 is a second wire stripping step of the wire feeding, stripping, and bonding sequence.

FIG. 15 is a first wire bonding step of the wire feeding, stripping, and bonding sequence.

FIG. 16 is a second wire bonding step of the wire feeding, stripping, and bonding sequence.

FIG. 17 is a wire cutter/stripper.

FIG. 18 is a wire rotation apparatus.

### DESCRIPTION

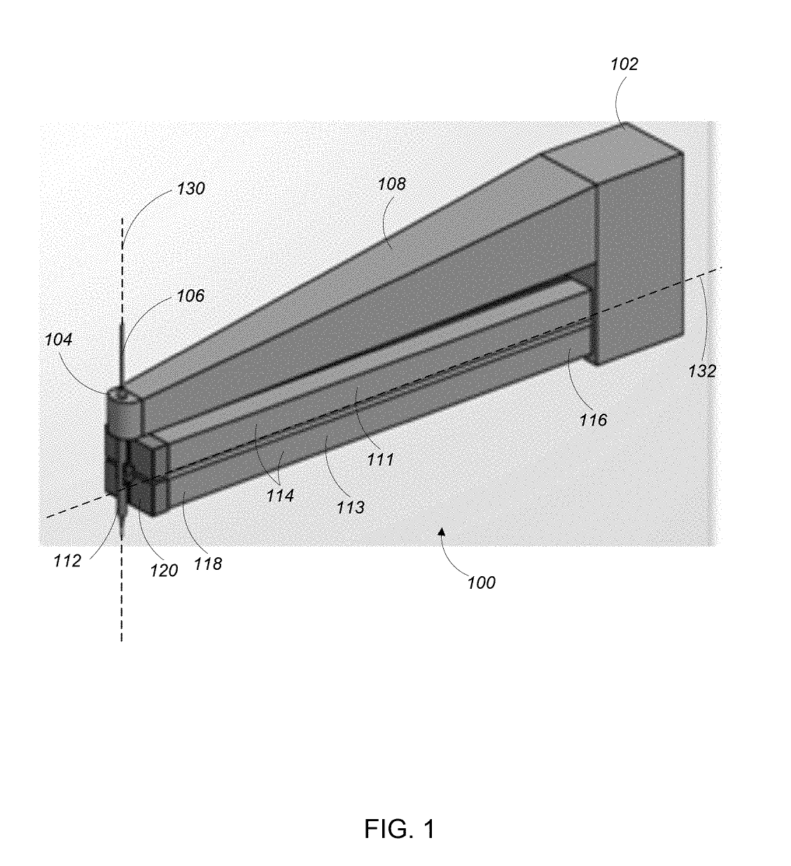

Referring to FIG. 1, a wire handling apparatus 100 is configured to precisely feed lengths of wire. The wire handling apparatus has a proximal end 102 and a distal end 104. In some examples, the proximal end 102 is attached to a multi-axis actuator such as a robotic arm (not shown). In some examples, the proximal end 102 is fixed in place relative to a multi-axis actuator such as an XY linear positioning table (not shown). The distal end 104 is configured to receive a wire 106 for feeding.

The wire handling apparatus 100 includes a frame 108 with a feed nozzle 112 as well as a first actuator 111 and a second actuator 113 attached thereto. Each of the first actuator 111 and the second actuator 113 includes two elongate two-dimensional (2D) piezoelectric actuators 114. Each of the 2D piezoelectric actuators 114 extends in a direction along a first axis 132 from a proximal end 116 of the 2D piezoelectric actuator 114 to a distal end 118 of the 2D piezoelectric actuator 114. The proximal end 116 of each of the 2D piezoelectric actuators 114 is attached to the frame 108 in proximity to the proximal end 102 of the wire handling apparatus 100.

The distal end 118 of each of the 2D piezoelectric actuators 114 is free and has a grasping member 120 disposed thereon. The feed nozzle 112 is an elongate tubular member extending through and affixed to the frame 108 in proximity to the distal end 104 of the wire handling apparatus 100. The feed nozzle includes a channel extending therethrough in a direction along a feeding axis 130. The wire 106 extends through the channel in the feed nozzle 112 in a direction along the feeding axis 130.

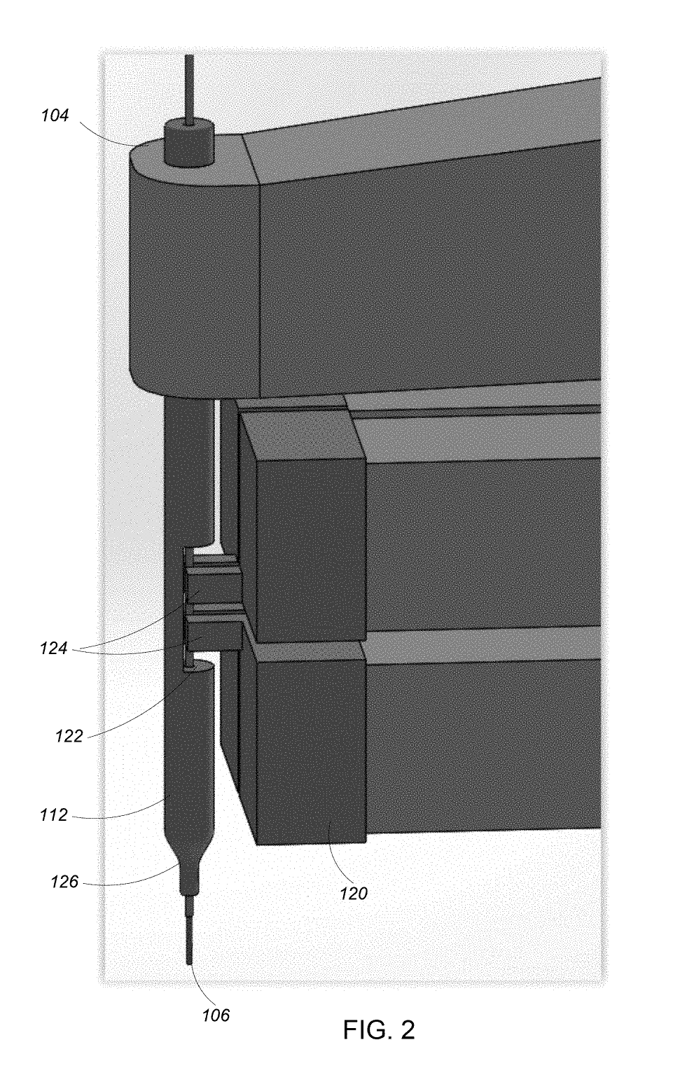

Referring to FIG. 2, a detailed view of the distal end 104 of the wire handling apparatus 100 shows the feed nozzle 112 as a tubular member with the wire 106 extending therethrough. The feed nozzle 112 includes a cut-out portion 122 through which the wire 106 can be accessed as well as a distal end 126 that is tapered.

Each of the grasping members 120 at the distal ends 118 of the 2D piezoelectric actuators 114 includes a finger 124 extending into the cut-out portion 122 of the feed nozzle 112 for interacting with the wire 106 in the cut-out portion 122.

Referring to FIG. 3, one example of a 2D piezoelectric actuator 114 is sometimes referred to as a ‘2D bender’ due to its ability to bend when a voltage is applied to the 2D piezoelectric actuator 114. With the proximal end 116 of the 2D piezoelectric actuator 114 affixed to a surface, the distal end 118 of the 2D piezoelectric actuator 114 is capable of moving, in two dimensions, in a direction along a first axis 226 and a second axis 228, perpendicular to the first axis 226. The distance and direction of movement of the distal end 118 of the 2D piezoelectric actuator 114 is determined by a magnitude and polarity of the voltage applied to the 2D piezoelectric actuator 114.

Referring again to FIG. 1, to feed the wire 106, the first actuator 111 and the second actuator 113 are controlled according to a wire feeding sequence to grasp, pull, and then release the wire 106 in such a way that the wire 106 is fed in a direction along the feeding axis 130 with high precision.

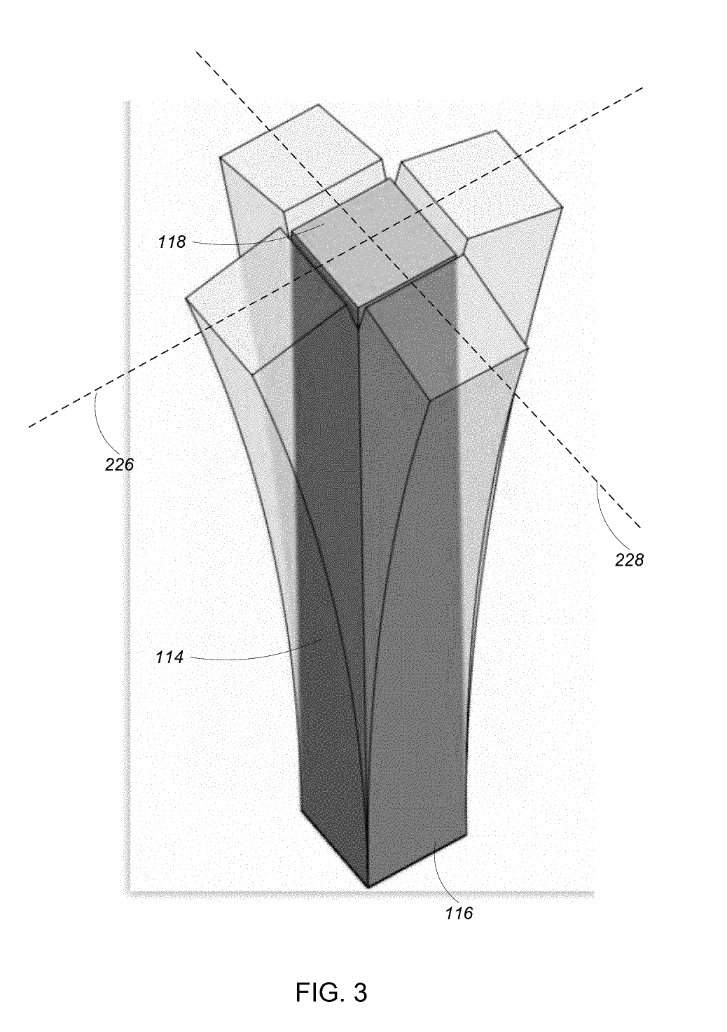

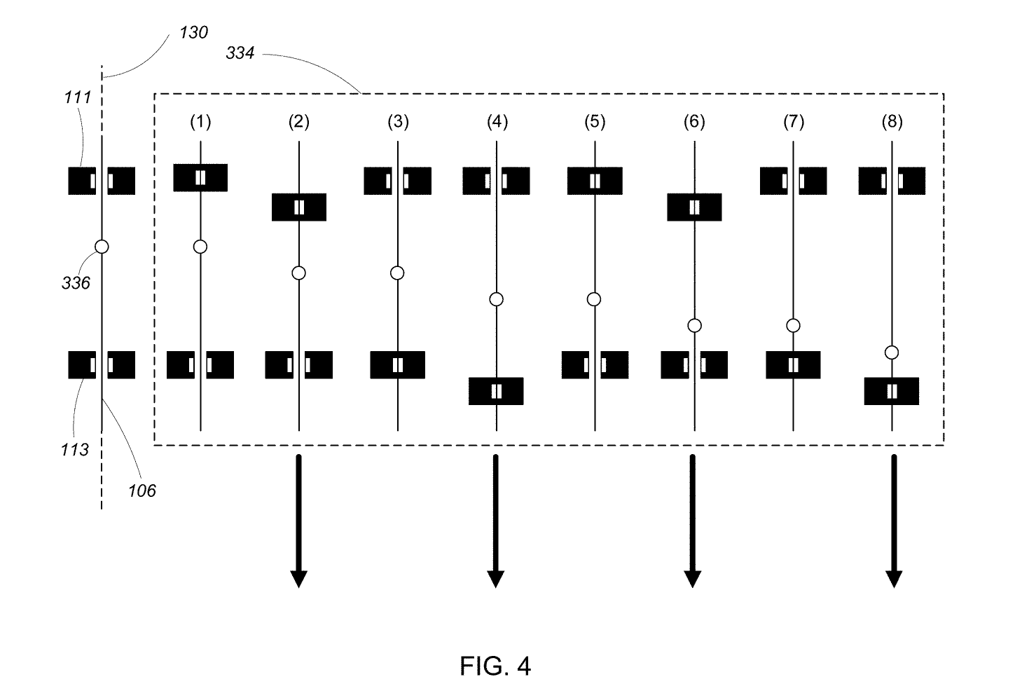

Referring to FIG. 4, one example of a wire feeding sequence 334 includes a number of steps for moving the wire 106 four units of distance. In some examples, each unit of distance in a range of 1/100 of an inch to 1/1000 of an inch. In FIG. 4, the grasping members 120 at the distal ends 118 of the 2D piezoelectric actuators 114 are viewed head on, looking down the first axis 132. A section of the wire 106 that is located in the cut-out portion 122 of the feed nozzle 112 is disposed between the grasping members 120 of the first actuator 111 and between the grasping members 120 of the second actuator 113. A reference point 336 is shown on the wire 106 for the sake of showing movement of the wire as the wire feeding sequence 334 progresses. The reference point 336 is not a physical feature of the wire 106 or any other part of the wire handling apparatus 100.

In a first step (1) of the wire feeding sequence 334, a first voltage is applied to the 2D piezoelectric actuators 114 of the first actuator 111, causing the 2D piezoelectric actuators 114 of the first actuator 111 to bend in a direction toward the wire 106. With the 2D piezoelectric actuators 114 of the first actuator 111 bent, the fingers 122 of the grasping elements 120 at the distal ends 118 of the 2D piezoelectric actuators 114 of the first actuator 111 grasp the wire 106. The 2D piezoelectric actuators 114 of the second actuator 113 remain unbent and the second actuator 113 does not engage the wire 106 in the first step (1).

In a second step (2) of the wire feeding sequence 334, a second voltage is applied to the 2D piezoelectric actuators 114 of the first actuator 111, causing the 2D piezoelectric actuators 114 of the first actuator 111 to remain bent in a direction toward the wire 106 such that the wire 106 remains grasped between the fingers 122 of the grasping elements 120 of the first actuator 111 and causing the 2D piezoelectric actuators 114 of the first actuator 111 to bend in a direction in a feeding direction along the feeding axis 130. The second step (2) causes a one distance unit displacement the wire 106 along the feeding axis 130 along the feeding direction, as is illustrated by the reference point 336 on the wire 106 being advanced. The 2D piezoelectric actuators 114 of the second actuator 113 remain unbent and the second actuator 113 does not engage the wire 106 in the second step (2).

In a third step (3) of the wire feeding sequence 334, the first voltage is applied to the 2D piezoelectric actuators 114 of the second actuator 113, causing the 2D piezoelectric actuators 114 of the second actuator 113 to bend in a direction toward the wire 106. With the 2D piezoelectric actuators 114 of the second actuator 113 bent, the fingers 122 of the grasping elements 120 at the distal ends 118 of the 2D piezoelectric actuators 114 of the second actuator 113 grasp the wire 106. With the wire 106 grasped by the second actuator 113, voltage is removed from the 2D piezoelectric actuators 114 of the first actuator 111, causing the 2D piezoelectric actuators to return to an unbent state where the first actuator does not engage the wire 106.

In a fourth step (4) of the wire feeding sequence 334, the second voltage is applied to the 2D piezoelectric actuators 114 of the second actuator 113, causing the 2D piezoelectric actuators 114 of the second actuator 113 to remain bent in a direction toward the wire 106 such that the wire 106 remains grasped between the fingers 122 of the grasping elements 120 of the second actuator 113 and causing the 2D piezoelectric actuators 114 of the second actuator 113 to bend in a direction in the feeding direction along the feeding axis 130. The fourth step (4) causes a one distance unit displacement the wire 106 along the feeding axis 130 along the feeding direction, as is illustrated by the reference point 336 on the wire 106 being advanced. The 2D piezoelectric actuators 114 of the first actuator 111 remain unbent and the first actuator 111 does not engage the wire 106 in the fourth step (4).

In a fifth step (5) of the wire feeding sequence 334, the first voltage is applied to the 2D piezoelectric actuators 114 of the first actuator 111, causing the 2D piezoelectric actuators 114 of the first actuator 111 to bend in a direction toward the wire 106. With the 2D piezoelectric actuators 114 of the first actuator 111 bent, the fingers 122 of the grasping elements 120 at the distal ends 118 of the 2D piezoelectric actuators 114 of the first actuator 111 grasp the wire 106. The 2D piezoelectric actuators 114 of the second actuator 113 remain unbent and the second actuator 113 does not engage the wire 106 in the fifth step (5).

In a sixth step (6) of the wire feeding sequence 334, the second voltage is applied to the 2D piezoelectric actuators 114 of the first actuator 111, causing the 2D piezoelectric actuators 114 of the first actuator 111 to remain bent in a direction toward the wire 106 such that the wire 106 remains grasped between the fingers 122 of the grasping elements 120 of the first actuator 111 and causing the 2D piezoelectric actuators 114 of the first actuator 111 to bend in a direction in a feeding direction along the feeding axis 130. The sixth step (6) causes a one distance unit displacement the wire 106 along the feeding axis 130 along the feeding direction, as is illustrated by the reference point 336 on the wire 106 being advanced. The 2D piezoelectric actuators 114 of the second actuator 113 remain unbent and the second actuator 113 does not engage the wire 106 in the sixth step (6).

In a seventh step (7) of the wire feeding sequence 334, the first voltage is applied to the 2D piezoelectric actuators 114 of the second actuator 113, causing the 2D piezoelectric actuators 114 of the second actuator 113 to bend in a direction toward the wire 106. With the 2D piezoelectric actuators 114 of the second actuator 113 bent, the fingers 122 of the grasping elements 120 at the distal ends 118 of the 2D piezoelectric actuators 114 of the second actuator 113 grasp the wire 106. With the wire 106 grasped by the second actuator 113, voltage is removed from the 2D piezoelectric actuators 114 of the first actuator 111, causing the 2D piezoelectric actuators to return to an unbent state where the first actuator does not engage the wire 106.

In an eighth step (8) of the wire feeding sequence 334, the second voltage is applied to the 2D piezoelectric actuators 114 of the second actuator 113, causing the 2D piezoelectric actuators 114 of the second actuator 113 to remain bent in a direction toward the wire 106 such that the wire 106 remains grasped between the fingers 122 of the grasping elements 120 of the second actuator 113 and causing the 2D piezoelectric actuators 114 of the second actuator 113 to bend in a direction in the feeding direction along the feeding axis 130. The eighth step (8) causes a one distance unit displacement the wire 106 along the feeding axis 130 along the feeding direction, as is illustrated by the reference point 336 on the wire 106 being advanced. The 2D piezoelectric actuators 114 of the first actuator 111 remain unbent and the first actuator 111 does not engage the wire 106 in the eighth step (8).

The wire feeding sequence 334 described above is one simple example of a wire feeding sequence where two actuators work in unison to advance the wire along a feeding direction while ensuring that at least one actuator is always grasping the wire such that the wire does not unintentionally retreat or advance due to factors such as inertia of the wire or the wire and spool. It is noted, however that many wire feeding sequences are possible. For example, the wire feeding sequence described above can be repeated to feed additional units of wire. Similarly, subsets of the wire feeding sequence described above can be used to feed fewer units of wire. In some examples, the 2D piezoelectric actuators described above and be moved with high frequency (e.g., 10 Hz-1000 Hz). In some examples, the wire feeding apparatus includes one or more sensors to measure an amount of wire that has been fed.

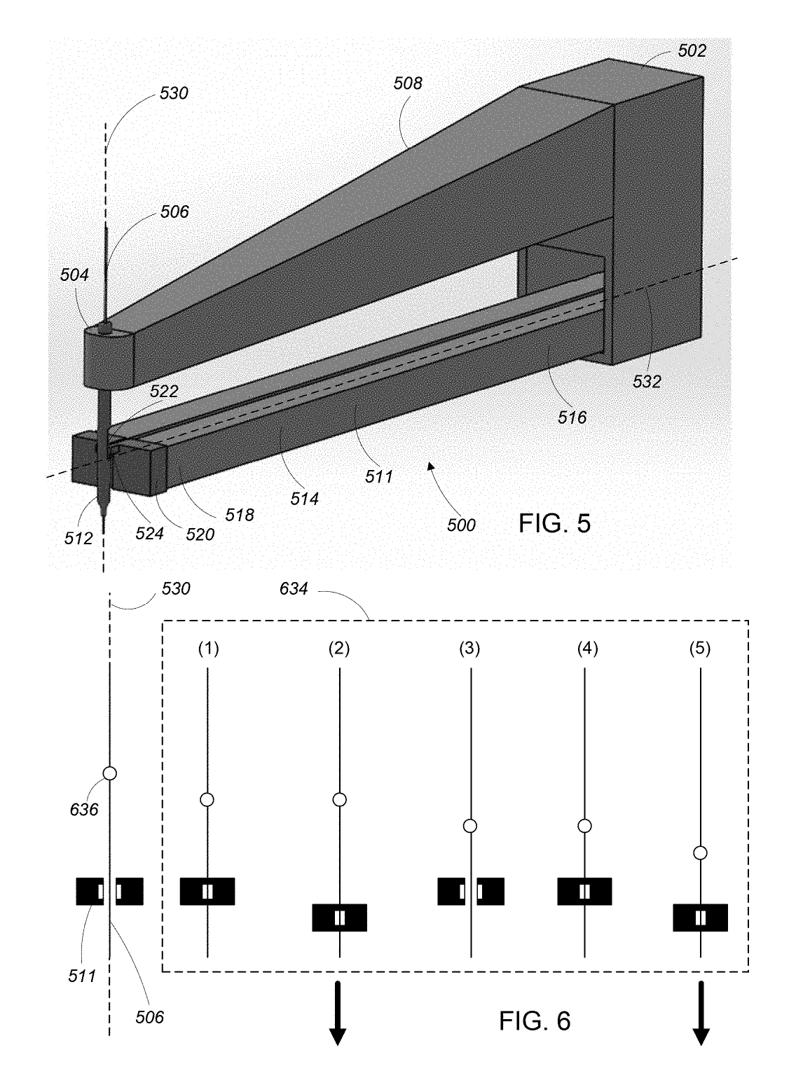

Referring to FIG. 5, another embodiment of a wire handling apparatus 500 has a proximal end 502 and a distal end 504. In some examples, the proximal end 502 is attached to a multi-axis actuator such as a robotic arm (not shown). In some examples, the proximal end 502 is fixed in place relative to a multi-axis actuator such as an XY linear positioning table (not shown). The distal end 504 is configured to receive wire 506 for feeding.

The wire handling apparatus 500 includes a frame 508 with a single actuator 511 and a feed nozzle 512 attached thereto. The actuator 511 includes two elongate two-dimensional (2D) piezoelectric actuators 514. Each of the 2D piezoelectric actuators 514 extends in a direction along a first axis 532 from a proximal end 516 of the 2D piezoelectric actuator 514 to a distal end 518 of the 2D piezoelectric actuator 514. The proximal end 516 of each of the 2D piezoelectric actuators 514 is attached to the frame 508 in proximity to the proximal end 502 of the wire handling apparatus 500. The distal end 518 of each of the 2D piezoelectric actuators 514 is free and has a grasping member 520 disposed thereon. The feed nozzle 512 is an elongate tubular member extending through and affixed to the frame 508 in proximity to the distal end 504 of the wire handling apparatus 500. The feed nozzle includes a channel extending therethrough in a direction along a feeding axis 530. The wire 506 extends through the channel in the feed nozzle 112 in a direction along the feeding axis 530.

As was the case with the wire handling apparatus 100 of FIG. 1, the feed nozzle 512 of the wire handling apparatus includes a cut-out portion 522 through which the wire 506 can be accessed as well as a distal end 526 that is tapered.

Each of the grasping members 520 at the distal ends 518 of the 2D piezoelectric actuators 514 includes a finger 524 extending into the cut-out portion 522 of the feed nozzle 512 for interacting with the wire 506 in the cut-out portion 522.

Referring to FIG. 6, an example of a wire feeding sequence 634 for the wire handling apparatus 500 of FIG. 5 includes a number of steps for moving the wire 506 two units of distance. In FIG. 6, the grasping members 520 at the distal ends 518 of the 2D piezoelectric actuators 514 are viewed head on, looking down the first axis 532. A section of the wire 506 that is located in the cut-out portion 522 of the feed nozzle 512 is disposed between the grasping members 520 of the actuator 511. A reference point 636 is shown on the wire 506 for the sake of showing movement of the wire as the wire feeding sequence 634 progresses. The reference point 636 is not a physical feature of the wire 506 or any other part of the wire handling apparatus 500.

In a first step (1) of the wire feeding sequence 634, a first voltage is applied to the 2D piezoelectric actuators 514 of the actuator 511, causing the 2D piezoelectric actuators 514 of the actuator 511 to bend in a direction toward the wire 506. With the 2D piezoelectric actuators 514 of the actuator 511 bent, the fingers 522 of the grasping elements 520 at the distal ends 518 of the 2D piezoelectric actuators 514 of the actuator 511 grasp the wire 506.

In a second step (2) of the wire feeding sequence 634, a second voltage is applied to the 2D piezoelectric actuators 514 of the actuator 511, causing the 2D piezoelectric actuators 514 of the actuator 511 to remain bent in a direction toward the wire 506 such that the wire 506 remains grasped by the fingers 522 and causing the 2D piezoelectric actuators 514 of the actuator 511 to bend in a direction along the feeding axis 530. The second step (2) therefore causes a one distance unit displacement the wire 506 along the feeding axis 530, as is illustrated by the reference point 636 on the wire 506 being advanced.

In a third step (3) of the wire feeding sequence 634, voltage is removed from the 2D piezoelectric actuators 514 of the actuator 511, causing the 2D piezoelectric actuators 514 to return to an unbent state where the actuator 511 does not engage the wire 506.

In a fourth step (4) of the wire feeding sequence 634, the first voltage is applied to the 2D piezoelectric actuators 514 of the actuator 511, causing the 2D piezoelectric actuators 514 of the actuator 511 to bend in a direction toward the wire 506. With the 2D piezoelectric actuators 514 of the actuator 511 bent, the fingers 522 of the grasping elements 520 at the distal ends 518 of the 2D piezoelectric actuators 514 of the actuator 511 grasp the wire 506.

In a fifth step (5) of the wire feeding sequence 634, the second voltage is applied to the 2D piezoelectric actuators 514 of the actuator 511, causing the 2D piezoelectric actuators 514 of the actuator 511 to remain bent in a direction toward the wire 506 such that the wire 506 remains grasped by the fingers 522 and causing the 2D piezoelectric actuators 514 of the actuator 511 to bend in a direction along the feeding axis 530. The second step (5) therefore causes a second, one distance unit displacement the wire 506 along the feeding axis 530, as is illustrated by the reference point 636 on the wire 506 being advanced.

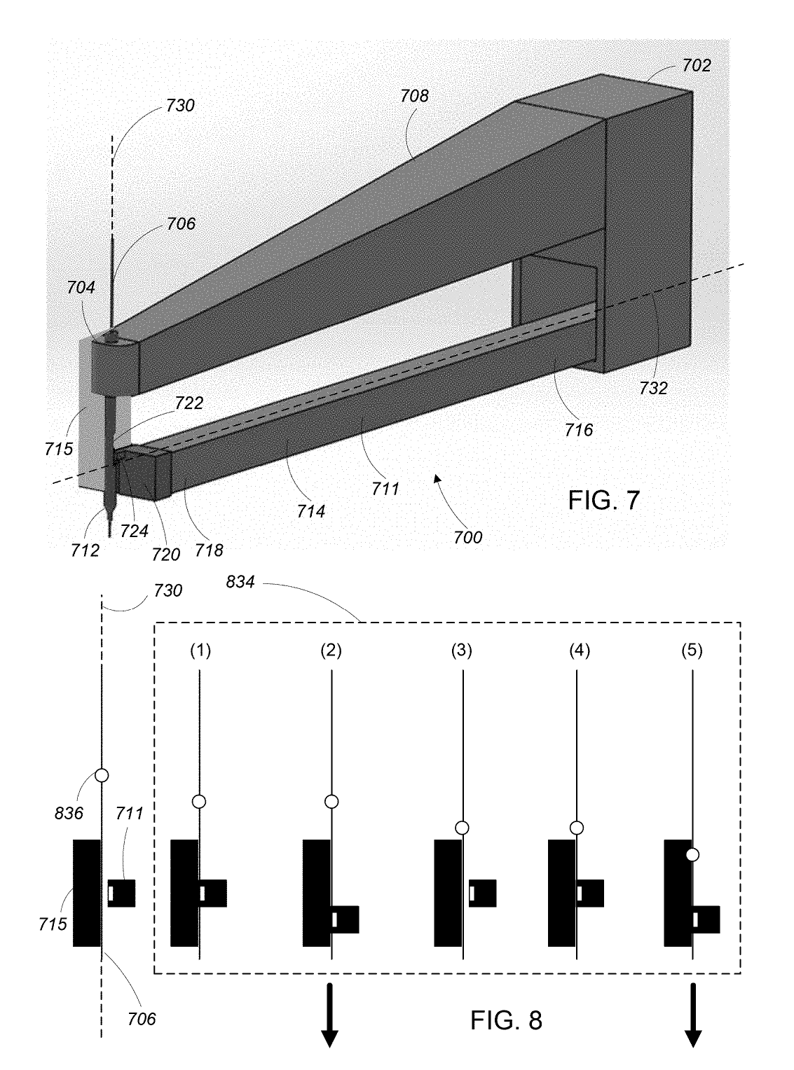

Referring to FIG. 7, another embodiment of a wire handling apparatus 700 has a proximal end 702 and a distal end 704. In some examples, the proximal end 702 is attached to a multi-axis actuator such as a robotic arm (not shown). In some examples, the proximal end 702 is fixed in place relative to a multi-axis actuator such as an XY linear positioning table (not shown). The distal end 704 is configured to receive wire 706 for feeding.

The wire handling apparatus 700 includes a frame 708 with a single actuator 711 and a feed nozzle 712 attached thereto. The actuator 711 includes one elongate two-dimensional (2D) piezoelectric actuators 714 that is configured to interact with a stationary backstop 715 to feed the wire 706. The 2D piezoelectric actuator 714 extends in a direction along a first axis 732 from a proximal end 716 of the 2D piezoelectric actuator 714 to a distal end 718 of the 2D piezoelectric actuator 714. The proximal end 716 of the 2D piezoelectric actuator 714 is attached to the frame 708 in proximity to the proximal end 702 of the wire handling apparatus 700. The distal end 718 of the 2D piezoelectric actuator 714 is free and has a grasping member 720 disposed thereon. The backstop 715 is attached to the frame 708 proximate to the distal end of the wire handling apparatus 700 and is disposed opposite a side of the distal end 718 of the 2D piezoelectric actuator 714.

The feed nozzle 712 is an elongate tubular member extending through and affixed to the frame 708 in proximity to the distal end 704 of the wire handling apparatus 700. The feed nozzle 712 includes a channel extending therethrough in a direction along a feeding axis 730. The wire 706 extends through the channel in the feed nozzle 712 in a direction along the feeding axis 730.

As was the case with the wire handling apparatus 100 of FIG. 1, the feed nozzle 712 of the wire handling apparatus includes a cut-out portion 722 through which the wire 706 can be accessed as well as a distal end 726 that is tapered.

The grasping member 720 at the distal end 718 of the 2D piezoelectric actuator 714 includes a finger 724 extending into the cut-out portion 722 of the feed nozzle 712 for interacting with the wire 706 in the cut-out portion 722 to press the wire 706 against the backstop 715.

Referring to FIG. 8, an example of a wire feeding sequence 834 for the wire handling apparatus 700 of FIG. 7 includes a number of steps for moving the wire 706 two units of distance. In FIG. 8, the grasping member 720 at the distal end 718 of the 2D piezoelectric actuator 714 are viewed head on, looking down the first axis 732. A section of the wire 706 that is located in the cut-out portion 722 of the feed nozzle 712 is disposed between the grasping member 720 of the actuator 711 and the backstop 715. A reference point 836 is shown on the wire 706 for the sake of showing movement of the wire as the wire feeding sequence 834 progresses. The reference point 836 is not a physical feature of the wire 706 or any other part of the wire handling apparatus 700.

In a first step (1) of the wire feeding sequence 834, a first voltage is applied to the 2D piezoelectric actuator 714 of the actuator 711, causing the 2D piezoelectric actuator 714 of the actuator 711 to bend in a direction toward the wire 706. With the 2D piezoelectric actuator 714 of the actuator 711 bent, the finger 722 of the grasping element 720 at the distal end 718 of the 2D piezoelectric actuator 714 of the actuator 711 presses the wire 706 against the backstop 715.

In a second step (2) of the wire feeding sequence 834, a second voltage is applied to the 2D piezoelectric actuator 714 of the actuator 711, causing the 2D piezoelectric actuator 714 of the actuator 711 to remain bent in a direction toward the wire 706 such that the wire 706 remains pressed against the backstop 715 and causing the 2D piezoelectric actuator 714 of the actuator 711 to bend in a direction along the feeding axis 730. In general, a coefficient of friction of the finger 722 of the grasping element 720 is substantially higher than a coefficient of friction of the backstop 715 (e.g., the backstop 715 is made of a Teflon-like material) such that the finger 722 causes movement of the wire 706 along the backstop 715 when the finger 722 is pressing the wire 706 against the backstop 715. The second step (2) therefore causes a one distance unit displacement the wire 706 along the feeding axis 730 along the feeding direction, as is illustrated by the reference point 836 on the wire 706 being advanced.

In a third step (3) of the wire feeding sequence 834, voltage is removed from the 2D piezoelectric actuator 714 of the actuator 711, causing the 2D piezoelectric actuator 714 to return to an unbent state where the actuator 711 does not engage the wire 706.

In a fourth step (4) of the wire feeding sequence 834, the first voltage is applied to the 2D piezoelectric actuator 714 of the actuator 711, causing the 2D piezoelectric actuator 714 of the actuator 711 to bend in a direction toward the wire 706. With the 2D piezoelectric actuator 714 of the actuator 711 bent, the finger 722 of the grasping element 720 at the distal end 718 of the 2D piezoelectric actuator 714 of the actuator 711 presses the wire 706 against the backstop 715.

In a fifth step (5) of the wire feeding sequence 834, the second voltage is applied to the 2D piezoelectric actuator 714 of the actuator 711, causing the 2D piezoelectric actuator 714 of the actuator 711 to remain bent in a direction toward the wire 706 such that the wire 706 remains pressed against the backstop 715 and causing the 2D piezoelectric actuator 714 of the actuator 711 to bend in a direction along the feeding axis 730. The fifth step (5) causes a second, one distance unit displacement the wire 706 along the feeding axis 730 along the feeding direction, as is illustrated by the reference point 836 on the wire 706 being advanced.

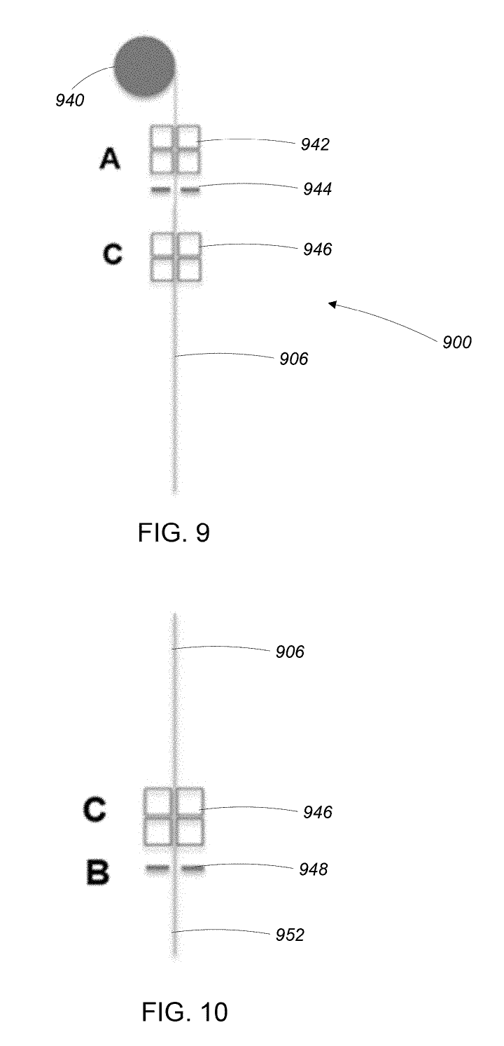

Referring to FIGS. 9-14, a wire feeding and stripping system uses one or more of the above-described wire handling apparatuses, along with wire cutting, rotation, stripping, and bonding apparatuses (described below) to feed, cut, strip, and bond a wire.

Referring to FIG. 9, the wire feeding and stripping system 900 includes a spool of wire 940, a first wire handling apparatus 942, wire cutter 944 attached to the first wire handling apparatus 942, and a second wire handling apparatus 946.

The first wire handling apparatus 940 feeds a desired length of wire 906 from the spool 940. In some examples, the length of wire 906 is fed through the second wire handling apparatus 946 while the second wire handling apparatus 946 remains disengaged from the wire 906. In some examples, the second wire handling apparatus 946 assists the first wire handling apparatus 940 in feeding the desired length of wire 906. With the desired length of wire 906 successfully fed, the second wire handling apparatus 946 grasps the wire 906 and the wire cutter 944 cuts the wire 906.

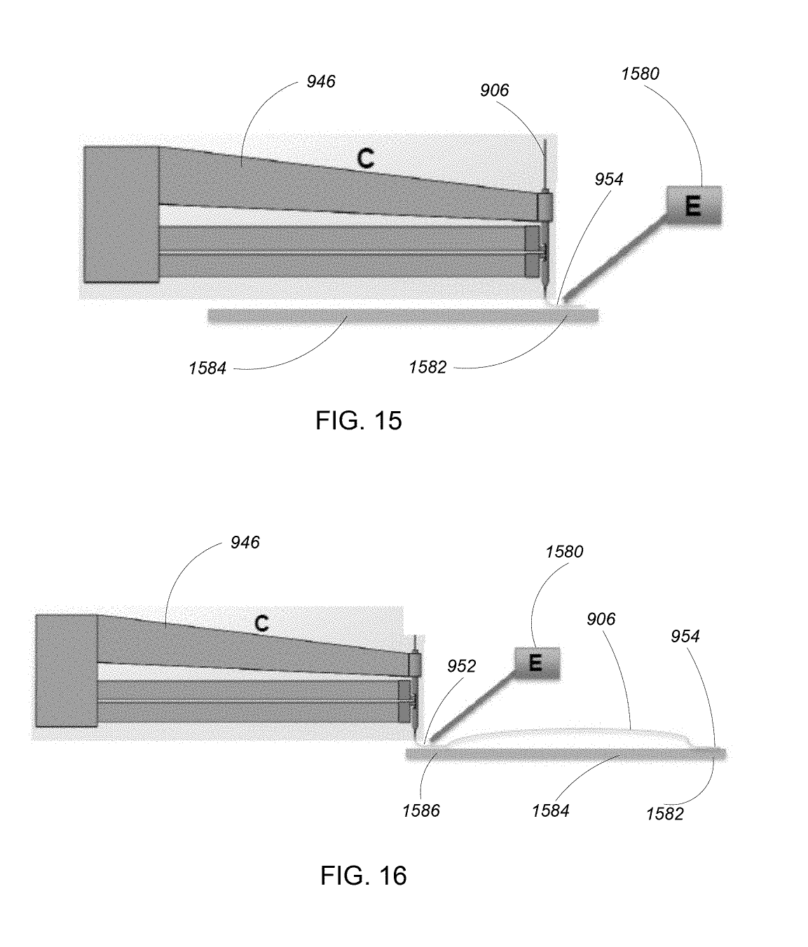

Referring to FIG. 10, with the wire 906 cut, the second wire handling apparatus 946 transports the wire 906 to a wire stripper 948. The wire stripper 948 strips an insulating layer and/or a shield layer (not shown) from a desired length of the wire 906 at a first end 952 of the wire 906. It is noted, in some examples, the wire stripper 948 is moved to the wire 906 rather than the wire 906 being moved to the wire stripper 948. One example of the wire stripper is described in greater detail below with reference to FIG. 15.

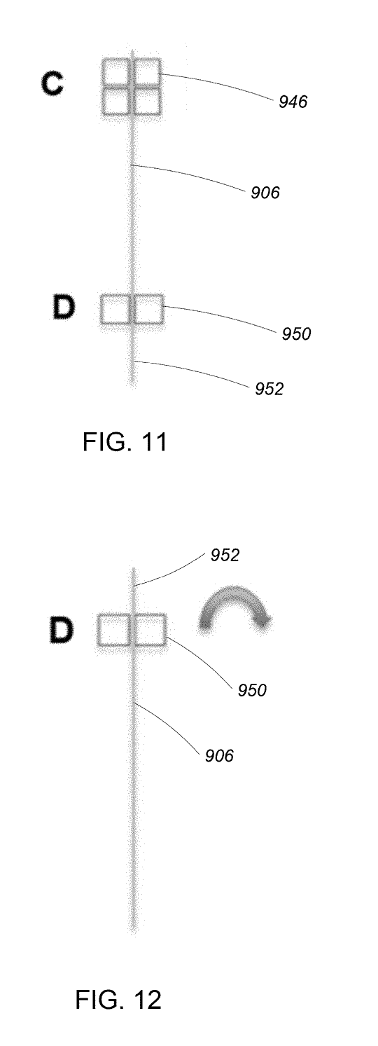

Referring to FIG. 11, with the wire 906 stripped, the second wire handling apparatus 946 transports the wire 906 to a wire rotation apparatus 950 that is configured to grasp and rotate the wire 906. The wire rotation apparatus 950 grasps the wire 906 in proximity to the first end 952 of the wire 906. It is noted, in some examples, the wire rotation apparatus 950 is moved to the wire 906 rather than the wire 906 being moved to the rotation apparatus 950. One example of the wire rotation apparatus 950 is described in greater detail below with reference to FIG. 16.

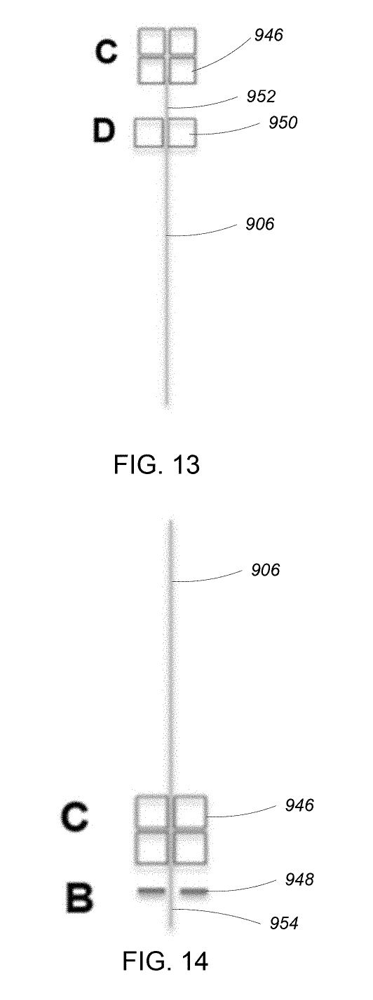

Referring to FIG. 12, the wire rotation apparatus 950 rotates the wire 180 degrees. Referring to FIG. 13, the second wire handling apparatus 946 grasps the first end 952 of the wire 906. The wire rotation apparatus 950 releases the wire 906 and the wire 906 is removed from the wire rotation apparatus 950.

Referring to FIG. 14, the second wire handling apparatus 946 feeds the wire 906 until a desired length at a second end 954 of the wire 906 protrudes from the second wire handling apparatus 946. The second end 954 of the wire 906 is then placed into the wire stripper 948 strips the insulating layer and/or shield layer (not shown) from the second end 954 of the wire 906. With the first end 952 and the second end 954 of the wire 906 stripped, the wire is prepared for bonding.

Referring to FIG. 15, the second wire handling apparatus 946 delivers the second end 954 of the wire 906 to a first bonding location 1582 on a substrate 1584. The second wire handling apparatus 946 places the second end 954 of the wire 906 on the first bonding location 1582 and a wire bonding apparatus 1580 (e.g., a thermosonic bonder or an ultrasonic bonder) bonds the second end 954 of the wire 906 to the first bonding location 1582.

Referring to FIG. 16, with the second end 954 of the wire 906 attached to the first bonding location 1582, the second wire handling apparatus 946 delivers the first end 952 of the wire 906 to a second bonding location 1586 on the substrate 1584. The second wire handling apparatus 946 places the first end 952 of the wire 906 on the second bonding location 1586 and the wire bonding apparatus 1580 bonds the first end 952 of the wire 906 to the second bonding location 1586.

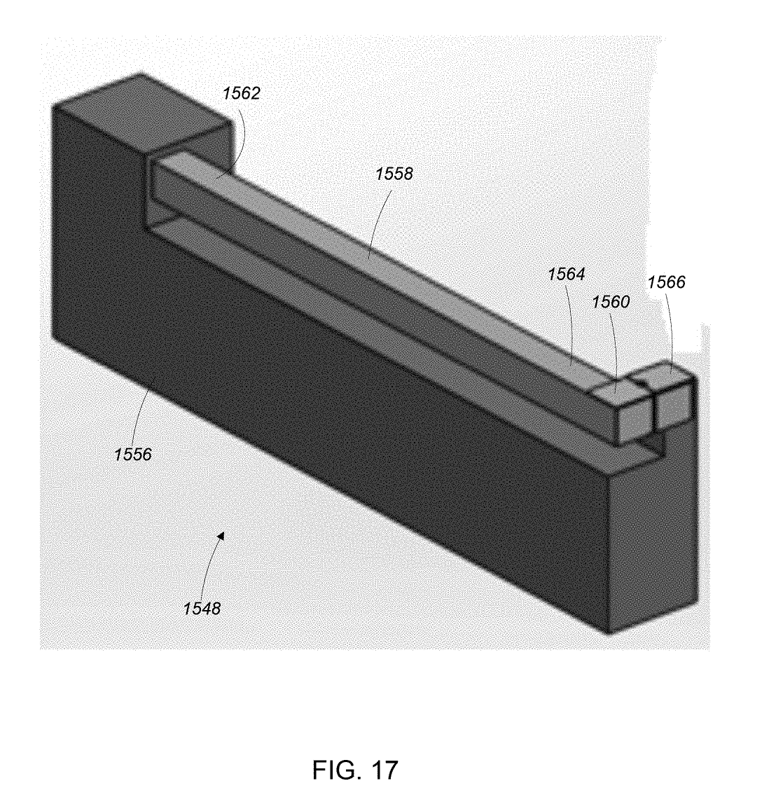

Referring to FIG. 17, one example of a wire stripping apparatus 1548 includes a frame 1556 with an actuator 1558 coupled thereto. A proximal end 1562 of the actuator 1558 is attached to the frame 1556 and a distal end 1564 of the actuator 1558 is free. A first cutting blade 1560 is attached to the distal end 1564 of the actuator 1558 and is oriented opposite a second cutting blade 1566, which is attached to the frame 1556. In some examples, the actuator 1558 is a 2D piezoelectric actuator which is configured to move the first cutting blade 1560 relative to the second cutting blade 1566 such that the blades 1560, 1566 engage a wire for stripping and/or cutting the wire. In some examples, wire stripping is accomplished using a 2D piezoelectric actuator with a head that vibrates against a side of the wire to etch or whittle one or more layers (e.g. a shield layer and/or an insulator layer) of the wire away.

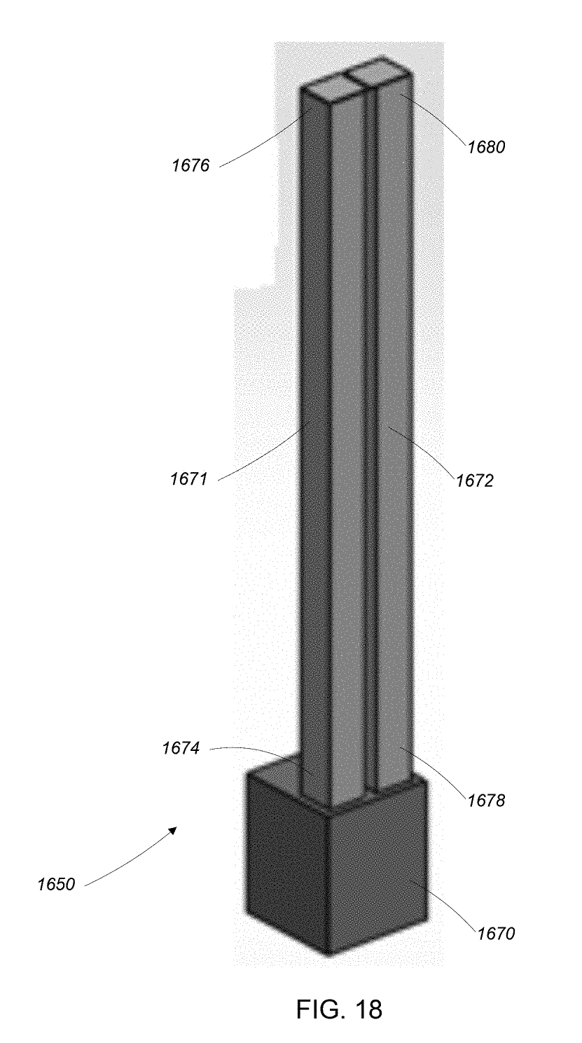

Referring to FIG. 18, one example of a wire rotation apparatus 1650 includes a frame 1670 with a first actuator 1671 and a second actuator 1674 coupled thereto. A proximal end 1674 of the first actuator 1671 is attached to the frame 1670 and a distal end 1676 of the first actuator 1671 is free. A proximal end 1678 of the second actuator 1672 is attached to the frame 1670 and a distal end 1680 of the second actuator 1672 is free. In some examples, the first actuator 1671 and the second actuator 1672 are both 2D piezoelectric actuators configured move the distal ends 1676 and 1680 of the first actuator 1671 and the second actuator 1672, respectively, together such that a wire disposed between the distal ends 1676, 1680 is grasped. In some examples, the frame 1670 is attached to an articulating arm or another device capable of rotation for rotation of a wire grasped by the first actuator 1671 and the second actuator 1672.

It is to be understood that the foregoing description is intended to illustrate and not to limit the scope of the invention, which is defined by the scope of the appended claims. Other embodiments are within the scope of the following claims.

What is claimed is:

1. A wire handling tool comprising:
a frame;
a first actuator having a proximal end attached to the frame and a first distal end including a first grasping member for grasping a wire, the first distal end configured to move along a first axis, wherein movement of the first distal end causes movement of the grasped wire along the first axis;
a controller for controlling the first actuator according to a wire feeding sequence to move the wire along the first axis.

2. The wire handling tool of claim 1 wherein the first actuator is movable between
a first configuration of the wire feeding sequence with the first grasping member of the first distal end of the first actuator disengaged from the wire, the first distal end of the first actuator being disposed at a first position on the first axis,
a second configuration of the wire feeding sequence with the first grasping member of the first distal end of the first actuator grasping the wire, the first distal end of the first actuator being disposed at the first position on the first axis,
a third configuration of the wire feeding sequence with the first grasping member of the first distal end of the first actuator grasping the wire, the first distal end of the first actuator being disposed at a second position on the first axis, and
a fourth configuration of the wire feeding sequence with the first grasping member of the first distal end of the first actuator disengaged from the wire, the first distal end of the first actuator being disposed at the second position on the first axis,
wherein a transition between the second configuration and the third configuration causes movement of the wire along the first axis.

3. The wire handling tool of claim 1 wherein the first actuator includes a plurality of sub-actuators, each sub-actuator of the plurality of sub-actuators having a proximal end attached to the frame and a distal end including a grasping element, wherein the corresponding grasping elements of the plurality of elongate sub-actuators form the first grasping member.

4. The wire handling tool of claim 3 wherein the distal end of each sub-actuator of the plurality of sub-actuators is configured to move in a plurality of directions including a direction along the first axis and a direction transverse to the first axis.

5. The wire handling tool of claim 4 wherein each sub-actuator of the plurality of sub-actuators includes an elongate piezoelectric actuator configured move the distal end of the sub-actuator by bending in response to an electrical stimulus.

6. The wire handling tool of claim 1 further comprising a second actuator having a second proximal end attached to the frame and a second distal end including a second grasping member for grasping the wire, the second distal end configured to move along the first axis, wherein movement of the second distal end causes movement of the grasped wire along the first axis, and the controller is further configured to control the second actuator according to the wire feeding sequence to move the wire along the first axis.

7. The wire handling tool of claim 6 wherein the first actuator and the second actuator are movable between
a first configuration of the wire feeding sequence with the first grasping member of the first distal end of the first actuator disengaged from the wire and the second grasping member of the second distal end of the second actuator grasping a first portion of the wire, the second distal end being disposed at a first position on the first axis,
a second configuration of the wire feeding sequence with the first grasping member of the first distal end of the first actuator disengaged from the wire and second grasping member of the second distal end of the second actuator grasping the first portion of the wire, the second distal end being disposed at a second position on the first axis,
a third configuration of the wire feeding sequence with the second grasping member of the second distal end of the second actuator disengaged from the wire and first grasping member of the first distal end of the first actuator grasping a second portion of the wire, the first distal end being disposed at a third position on the first axis, and
a fourth configuration of the wire feeding sequence with the second grasping member of the second distal end of the second actuator disengaged from the wire and the first grasping member of the first distal end of the first actuator grasping the second portion of the wire, the first distal end being disposed at a fourth position on the first axis
wherein a transition from the first configuration to the second configuration causes movement of the wire along the first axis and a transition from the third configuration to the fourth configuration causes movement of the wire along the first axis.

8. The wire handling tool of claim 6 wherein the first actuator includes a first plurality of sub-actuators, each sub-actuator of the first plurality of sub-actuators having a proximal end attached to the frame and a distal end including a grasping element, wherein the corresponding grasping elements of the first plurality of elongate sub-actuators form the first grasping member and the second actuator includes a second plurality of sub-actuators, each sub-actuator of the second plurality of sub-actuators having a proximal end attached to the frame and a distal end including a grasping element, wherein the corresponding grasping elements of the second plurality of elongate sub-actuators form the second grasping member.

9. The wire handling tool of claim 8 wherein the distal end of each sub-actuator of the first plurality of sub-actuators is configured to move in a first plurality of directions including a direction along the first axis and a direction transverse to the first axis and the distal end of each sub-actuator of the second plurality of sub-actuators is configured to move in a second plurality of directions including a direction along the first axis and a direction transverse to the first axis.

10. The wire handling tool of claim 9 wherein each sub-actuator of the first plurality of sub-actuators includes an elongate piezoelectric actuator configured move the distal end of the sub-actuator by bending in response to an electrical stimulus and each sub-actuator of the second plurality of sub-actuators includes an elongate piezoelectric actuator configured move the distal end of the sub-actuator by bending in response to an electrical stimulus.

11. The wire handling tool of claim 1 further comprising a substantially cylindrical elongate nozzle coupled to the frame and extending along the first axis, the nozzle having a channel extending therethrough for receiving the wire.

12. The wire handling tool of claim 11 wherein a sidewall of the nozzle includes an opening through which the first grasping member extends for accessing the wire.

13. The wire handling tool of claim 1 further comprising a wire stripping apparatus including a second frame with a first wire stripping blade attached thereto and a wire stripping actuator having a proximal end attached to the second frame and a distal end with a second wire stripping blade attached thereto, wherein the first wire stripping blade opposes the second wire stripping blade.

14. The wire handling tool of claim 13 wherein the controller is further configured to control the wire stripping actuator according to a wire stripping sequence.

15. The wire handling tool of claim 1 further comprising a rotation actuator for grasping and rotating the wire.

16. The wire handling tool of claim 1 further comprising a bonding member for attaching the wire to a surface.

17. A wire handling tool comprising:
a frame;
a contact surface;
an actuator having a proximal end attached to the frame and a distal end, the distal end configured to move in a direction along a first axis and configured to move in a direction transverse to the first axis for pressing the wire against the contact surface, wherein movement of the distal end along the first axis when the wire is pressed against the contact surface causes movement of the wire along the first axis;
a controller for controlling the actuator according to a wire feeding sequence to move the wire along the first axis.

18. The wire handling tool of claim 17 wherein the actuator is movable between
a first configuration of the wire feeding sequence with the distal end of the actuator disengaged from the wire, the distal end of the actuator being disposed at a first position along the first axis,
a second configuration of the wire feeding sequence with the distal end of the actuator pressing the wire against the contact surface, the distal end of the actuator being disposed at the first position along the first axis,
a third configuration of the wire feeding sequence with the distal end of the actuator pressing the wire against the contact surface, the distal end of the actuator being disposed at a second position along the first axis, and
a fourth configuration of the wire feeding sequence with the distal end of the actuator disengaged from the wire, the distal end of the actuator being disposed at the second position along the first axis,
wherein transitioning between the second configuration of the wire feeding sequence and the third configuration of the wire feeding sequence causes movement of the wire along the first axis.

19. The wire handling tool of claim 18 wherein the distal end of the actuator is configured to move in a first plurality of directions including a direction along the first axis and a direction transverse to the first axis.

20. The wire handling tool of claim 19 wherein the actuator includes an elongate piezoelectric actuator, the elongate piezoelectric actuator configured move the distal end of the first by bending in response to an electrical stimulus and each sub-actuator of the second plurality of sub-actuators includes an elongate piezoelectric actuator configured move the distal end of the sub-actuator by bending in response to an electrical stimulus.

21. A method for feeding, stripping, and bonding a wire, the method comprising:
feeding a first portion of wire from a spool using a first wire handling tool;
cutting the first portion of wire using a wire cutting tool attached to the first wire handling tool;
grasping the first portion of wire using a second wire handling tool;
moving the first portion of wire to a wire stripping apparatus using the second wire handling tool and stripping a first end of the first wire portion of wire using the wire stripping apparatus;
grasping the first wire portion using a wire rotation apparatus and releasing the first portion of wire from the second wire handling tool;
rotating the first portion of wire using the wire rotation apparatus;
grasping the rotated first portion of wire using the second wire handling apparatus;
moving the first portion of wire to the wire stripping apparatus using the second wire handling tool and stripping a second end of the first wire portion using the wire stripping apparatus;
moving the second end of the first portion of wire to a first connection point using the second wire handling apparatus and attaching the second end of the first portion of wire to the first connection point using a bonding apparatus; and
moving the first end of the first portion of wire to a second connection point using the second wire handling apparatus and attaching the first end of the first portion of wire to the second connection point using the bonding apparatus.

22. The method of claim 21 wherein
the first wiring tool includes a frame, a first actuator having a proximal end attached to the frame and a first distal end including a first grasping member for grasping a wire, the first distal end configured to move along a first axis, wherein movement of the first distal end causes movement of the grasped wire along the first axis, and a controller for controlling the first actuator according to a wire feeding sequence to move the wire along the first axis; and
the second wiring tool includes a second actuator having a proximal end attached to the frame and a second distal end including a second grasping member for grasping a wire, the second distal end configured to move along a second axis, wherein movement of the second distal end causes movement of the grasped wire along the second axis, and a controller for controlling the second actuator according to a wire feeding sequence to move the wire along the second axis.
